(19) United States
(12) Patent Application Publication
(10) Pub. No.: US 2013/0235207 A1
(43) Pub. Date: Sep. 12, 2013

(54) DOOR ALARM SYSTEM AND ALARMING METHOD THEREOF

(71) Applicants: HOU-HSIEN LEE, Tu-Cheng, New Taipei (TW); CHANG-JUNG LEE, Tu-Cheng, New Taipei (TW); CHIH-PING LO, Tu-Cheng, New Taipei (TW)

(72) Inventors: HOU-HSIEN LEE, Tu-Cheng, New Taipei (TW); CHANG-JUNG LEE, Tu-Cheng, New Taipei (TW); CHIH-PING LO, Tu-Cheng, New Taipei (TW)

(21) Appl. No.: 13/662,571

(22) Filed: Oct. 29, 2012

(30) Foreign Application Priority Data
Mar. 8, 2012 (TW) 101107820

(51) Int. Cl. H04N 7/18

(52) U.S. Cl. 348/152; 348/E07.085

(57) ABSTRACT

An alarming method includes: capturing images around a door; determining whether a user has passed through the door by analyzing the captured images; detecting whether the door is closed after determining that the user has passed through the door; and executing an alarm operation to alarm the user to close the door after determining that the user has passed through the door and the door is opened. A door alarm system is also described.

### BACKGROUND

1. Technical Field

The present disclosure relates to alarm systems, and particularly to a door alarming system and an alarming method for alarming a user to close a door.

2. Description of Related Art

People may forget to close the door of their house when they go out or come back, which may cause safety issue. Therefore, what is needed is a means to solve the above mentioned problem.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a door alarm system, in accordance with an exemplary embodiment.

FIG. 2 is a schematic view showing the door alarm system of FIG. 1 applied in a door system, in accordance with an exemplary embodiment.

FIG. 3 is a flowchart of an alarming method, in accordance with an exemplary embodiment.

### DETAILED DESCRIPTION

Embodiments of the present disclosure will now be described in detail, with reference to the accompanying drawings.

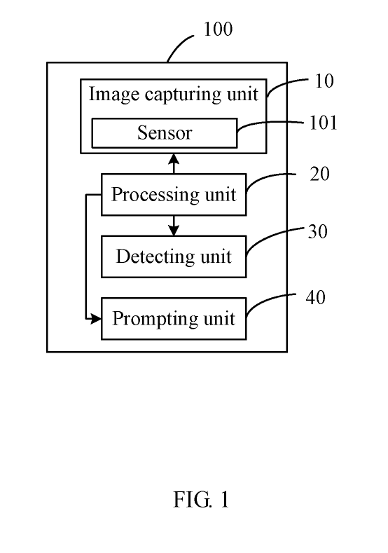

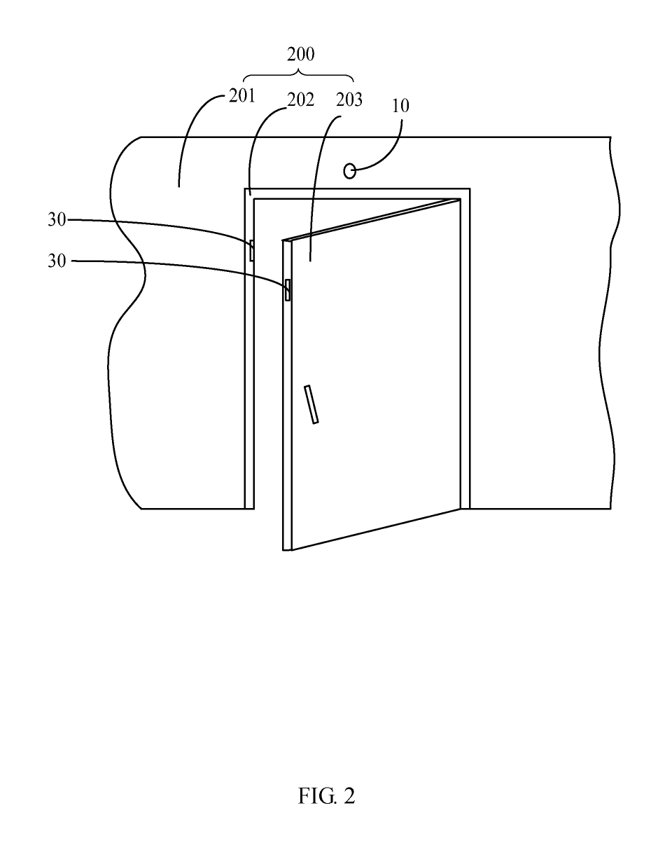

Referring to FIGS. 1-2, an embodiment of a door alarm system 100 applied in a door system 200 is illustrated. The door system 200 includes a wall 201, a door frame 202 mounted in the wall 201, and a panel door 203 hinged to the door frame 202. The alarm system 100 is used to detect whether the panel door 203 is closed after determining that a user has passed through the door 203, and prompt the user to close the door 203 if the door 203 is opened.

The alarm system 100 includes an image capturing unit 10, a processing unit 20, and a detecting unit 30.

The image capturing unit 10 is used to capture images around the panel door 203. In the embodiment, the image capturing unit 10 is a camera fixed on the door frame 202 or the wall 201, and the image capturing unit 10 captures images around the door 203 continuously. In an alternative embodiment, the image capturing unit 10 further includes a sensor 101, such as an infrared sensor, to detect whether a user has walked into a predetermined area; if so, the image capturing unit 10 captures images around the door 203.

The processing unit 20 obtains the images captured by the image capturing unit 10, and determines whether a user has passed through the door 203 by analyzing the obtained images using known technology. In detail, if a figure image appears in several sequential images, and the size of the figure image gradually increases or decreases, and then the figure image disappears from subsequent images, the processing unit 20 determines that a user has passed through the door 203.

After the processing unit 20 determines that the user has passed through the door 203, the processing unit 20 controls the detecting unit 30 to detect whether the door 203 is closed. In the embodiment, the detecting unit 30 includes an infrared emitter 301 and an infrared receiver 302. One of the infrared emitter 301 and the infrared receiver 302 are arranged on the door frame 202, and another one of the infrared emitter 301 and the infrared receiver 302 are arranged on the door 203. The infrared receiver 302 is arranged aligned with the infrared emitter 301. When the door 203 is closed, the infrared receiver 302 can receive the infrared ray emitted by the infrared emitter 301. If the infrared receiver 302 receives the infrared ray, the processing unit 20 determines that the door 203 is closed. Otherwise, the processing unit 20 determines that the door 203 is opened.

After the processing unit 20 determines that a user has passed through the door 203, and the door 203 is opened, the processing unit 20 executes an alarm operation to alarm the user to close the door 203. In the embodiment, the alarm system 100 further includes an alarm 40 mounted on the door system 200, such as a loudspeaker, a light, or the like. The processing unit 20 executes the alarm operation by controlling the alarm 40 to output alarm signal, for example, controlling the loudspeaker to output audible sound, or controlling the light to emit light. In an alternative embodiment, the processing unit 20 executes the alarm operation by sending a message to a preset communication account to alarm the user to close the door. The communication account may be a phone number of a mobile phone, an email account, or the like. In the embodiment, the processing unit 20 may execute the alarm operation after a predetermined time interval after determining that the user pass through the door 203 and does not close the door 203.

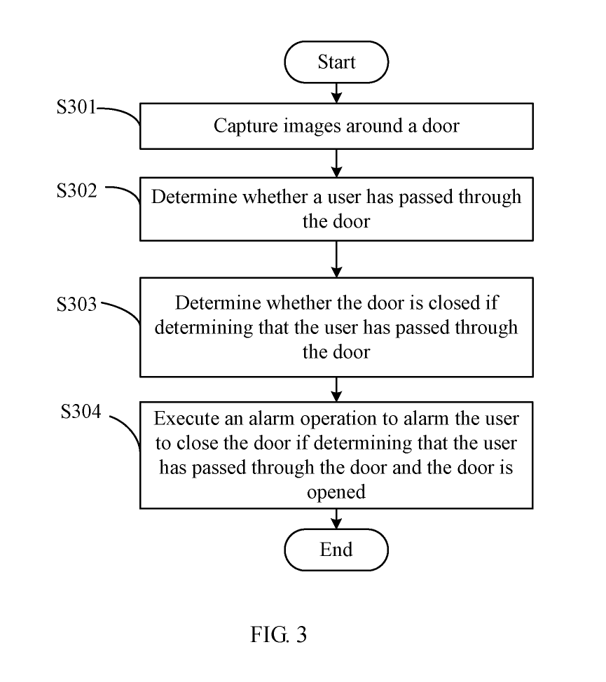

FIG. 3 is a flowchart of an alarming method, in accordance with an exemplary embodiment.

In step S301, the image capturing unit 10 captures images around the door 203.

In step S302, the processing unit 20 obtains the images captured by the image capturing unit 10 and determines whether a user has passed through the door 203 by analyzing the obtained images using known technology.

In step S303, the processing unit 20 controls the detecting unit 30 to detect whether the door 203 is closed after the processing unit 20 determines that the user has passed through the door 203.

In step S304, the processing unit 20 executes an alarm operation to alarm the user to close the door 203 after the processing unit 20 determines that the user has passed through the door 203 and the door 203 is opened.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A door alarm system applied in a door system, the door system comprising a wall, a door frame mounted in the wall, and a door, the door alarm system comprising:
an image capturing unit to capture images around the door;
a processing unit to obtain the images captured by the image capturing unit and analyze the obtained images to determine whether a user has passed through the door;
a detecting unit controlled by the processing unit to detect whether the door is closed after the processing unit determines that the user has passed through the door; and
the processing unit further to execute an alarm operation after determining that the user has passed through the door and the door is opened.

2. The alarm system as described in claim 1, wherein the image capturing unit is a camera fixed on one of the door frame and the wall.

3. The alarm system as described in claim 1, wherein the image capturing unit captures image continuously.

4. The alarm system as described in claim 1, wherein the image capturing unit further comprises a sensor, and the image capturing unit captures images around the door if the sensor detects that a user has walked into a predetermined area.

5. The alarm system as described in claim 1, wherein the processing unit determines that the user has passed through the door if a figure image appears in several sequential images, and the size of the figure image gradually increases or decreases, and then the figure image disappears from subsequent images.

6. The alarm system as described in claim 1, wherein the detecting unit further comprises an infrared emitter and an infrared receiver, one of the infrared emitter and the infrared receiver is arranged on the door frame, and another one of the infrared emitter and the infrared receiver is arranged on the door, the infrared receiver is aligned with the infrared emitter, when the door is closed, the infrared receiver receives the infrared ray emitted by the infrared emitter, and if the infrared receiver receives the infrared ray, the processing unit determines that the door is closed, otherwise, the processing unit determines that the door is opened.

7. The alarm system as described in claim 1, further comprising an alarm, wherein the processing unit executes the alarm operation by controlling the alarm to output alarm signal.

8. The alarm system as described in claim 7, wherein the alarm is a loudspeaker mounted on the door system, and the processing unit executes the alarm operation by controlling the loudspeaker to output audible alarm signal.

9. The alarm system as described in claim 7, wherein the alarm is a lighting unit mounted on the door system, and the processing unit executes the alarm operation by controlling the lighting unit to emit light.

10. The alarm system as described in claim 1, wherein the processing unit executes the alarm operation by send a message to a preset communication account.

11. The alarm system as described in claim 9, wherein the processing unit execute the alarm operation after a predetermined time interval after determining that the user pass through the door and the door is opened.

12. An alarming method applied to a door alarm system, the door alarm system being applied to a door system which comprising a wall, a door frame mounted in the wall, and a door, the alarming method comprising:
capturing images around the door;
analyzing the captured images to determine whether a user has passed through the door;
detecting whether the door is closed after determining that the user has passed through the door; and
executing an alarm operation to alarm the user to close the door after determining that the user has passed through the door and the door is opened.

13. The alarming method as described in claim 12, wherein the step of determining whether a user has passed through the door by analyzing the captured images comprises:
determining that the user has passed through the door if a figure image appears in several sequential images, and the size of the figure image gradually increases or decreases, and then the figure image disappears from subsequent images.
